(19) United States
(12) Patent Application Publication
(10) Pub. No.: US 2021/0223071 A1
(43) Pub. Date: Jul. 22, 2021

(54) ENERGY EFFICIENT ELECTROMECHANICAL DISLAY FOR GAUGES

(71) Applicant: Goodrich Corporation, Charlotte, NC (US)

(72) Inventors: Sivakumar Laguduwa, Thubarahalli (IN); Aswin Kumar Vallamkondu, Bangalore (IN); Jeffrey Martin Werbelow, Phoenix, AZ (US); Ashish Kumar Agarwal, Bangalore (IN)

(21) Appl. No.: 17/020,124

(22) Filed: Sep. 14, 2020

(30) Foreign Application Priority Data
Jan. 16, 2020 (IN) 202011001977

(51) Int. Cl. G01D 13/22; G01F 23/00; G01D 13/04; G01K 1/04

(52) U.S. Cl. CPC G01D 13/22; G01F 23/0007; B60K 37/02; G01K 1/04; G01D 13/04

(57) ABSTRACT

A gauge device is provided and includes an analog display to signify a measured valued, a motor and worm gear arrangement which is configured to retain a current state of the analog display when de-energized or to change the analog display when energized and a control system. The control system is configured to normally de-energize the motor and worm gear arrangement and to energize the motor and worm gear arrangement only in accordance with a calculated state of the analog display differing from the current state by at least a threshold level.

### CROSS-REFERENCE TO RELATED APPLICATIONS

This application claims the benefit of Indian Application No. 202011001977 filed Jan. 16, 2020, the disclosure of which is incorporated herein by reference in its entirety.

### BACKGROUND

The following description relates to electromechanical displays and, more particularly, an energy efficient electromechanical display for gauges.

In an aircraft, instrumentation is provided to pilots and copilots to help them navigate and fly. In this way, information can be presented to the pilot and the copilot. This information includes, but is not limited to, pressure information, temperature information, humidity information, fuel status information, etc., all of which do not change very frequently during the course of a given flight.

Though analog-based gauges of an aircraft typically do not have power consumption issues, there can be other issues related to accuracy and information storing, processing, sharing, etc., which are troublesome for analog-based gauges. When these parameters are displayed in digital-based systems, however, whether the actual displays are analog or digital, power consumption is an issue. This is especially true in an event the system is powered with a battery supply.

When analog gauges are used in electronic systems, a needle to display a measured quantity is driven by coils and gears and the coils need to be continuously energized to hold the needle position in order to display the measured value. This leads to substantial power consumption as the measured value is almost static. In digital displays, the digital display consumes power continuously irrespective of whether the information is refreshed or not.

### BRIEF DESCRIPTION

According to an aspect of the disclosure, a gauge device is provided and includes an analog display to signify a measured valued, a motor and worm gear arrangement which is configured to retain a current state of the analog display when de-energized or to change the analog display when energized and a control system. The control system is configured to normally de-energize the motor and worm gear arrangement and to energize the motor and worm gear arrangement only in accordance with a calculated state of the analog display differing from the current state by at least a threshold level.

In accordance with additional or alternative embodiments, the measured value includes a vehicle parameter that changes too slowly for human perception and the vehicle parameter includes one or more of pressure information, temperature information and fuel level information.

In accordance with additional or alternative embodiments, the analog display includes a numbered background and a needle disposed to point to any portion of the numbered background to signify the measured value.

In accordance with additional or alternative embodiments, the motor and worm gear arrangement includes a bi-directional motor, a worm gear disposed on an output shaft of the bi-directional motor and a gear train operably interposed between the worm gear and the analog display.

In accordance with additional or alternative embodiments, the gauge device further includes a battery from which power is drawn to energize the motor and worm gear arrangement.

In accordance with additional or alternative embodiments, the control system includes one or more sensors to provide readings of the measured value.

In accordance with additional or alternative embodiments, the control system includes a motor driver configured to energize the motor and worm gear arrangement, a position encoder configured to generate a first signal indicative of the current state of the analog display and a microcontroller. The microcontroller is configured to receive the signal from the position encoder, to recognize the current state from the first signal, to calculate the calculated state of the analog display in accordance with readings of the measured value, to compare the calculated and current states and to generate a second signal that instructs the motor driver to energize the motor and worm gear arrangement based on comparison results.

In accordance with additional or alternative embodiments, the threshold level is a level of change that is barely perceptible to a human.

According to another aspect of the disclosure, a gauge device is provided and includes an analog display to signify a measured value, a motor and worm gear arrangement to retain a current state of the analog display when de-energized and to drive a change in the analog display when energized and a control system. The control system is configured to normally maintain the motor and worm gear arrangement in a state in which the motor and worm gear arrangement is de-energized in accordance with a calculated state of the analog display differing from the current state by less than a threshold level and to energize the motor and worm gear arrangement only in accordance with the calculated state differing from the current state by at least the threshold level.

In accordance with additional or alternative embodiments, the measured value includes a vehicle parameter that changes too slowly for human perception and the vehicle parameter includes one or more of pressure information, temperature information and fuel level information.

In accordance with additional or alternative embodiments, the analog display includes a numbered background and a needle disposed to point to any portion of the numbered background to signify the measured value.

In accordance with additional or alternative embodiments, the motor and worm gear arrangement includes a bi-directional motor, a worm gear disposed on an output shaft of the bi-directional motor and a gear train operably interposed between the worm gear and the analog display.

In accordance with additional or alternative embodiments, the gauge device further includes a battery from which power is drawn to energize the motor and worm gear arrangement.

In accordance with additional or alternative embodiments, the control system includes one or more sensors to provide readings of the measured value.

In accordance with additional or alternative embodiments, the control system includes a motor driver configured to energize the motor and worm gear arrangement, a position encoder configured to generate a signal indicative of the current state of the analog display and a microcontroller. The microcontroller is configured to receive the first signal from the position encoder, to recognize the current state from the first signal, to calculate the calculated state of the analog display in accordance with readings of the measured value, to compare the calculated and current states and to generate a second signal that instructs the motor driver to energize the motor and worm gear arrangement based on comparison results.

In accordance with additional or alternative embodiments, the threshold level is a level of change that is barely perceptible to a human.

According to another aspect of the disclosure, a method of operating a gauge device is provided and includes maintaining a motor and worm gear arrangement in a de-energized state to retain a current state of an analog display to signify a measured value, calculating a calculated state of the analog display in accordance with readings of the measured value, determining whether a difference between the current and calculated states is above a threshold level, energizing the motor and worm gear arrangement to achieve the calculated state only in an event the difference between the current and calculated states is above the threshold level and de-energizing the motor and worm gear arrangement once the calculated state is achieved.

In accordance with additional or alternative embodiments, the measured value includes a vehicle parameter that changes too slowly for human perception and the vehicle parameter includes one or more of pressure information, temperature information and fuel level information.

In accordance with additional or alternative embodiments, the threshold level is a difference that is barely perceptible to a human.

In accordance with additional or alternative embodiments, the energizing and the de-energizing includes battery power management.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a display gauge with a needle to signify a measure value in accordance with embodiments;

FIG. 2 is a perspective view of a motor and a worm gear arrangement of an underside of the display gauge of FIG. 1 in accordance with embodiments;

FIG. 3 is a perspective view of the worm gear arrangement of FIG. 2 in accordance with embodiments;

FIG. 4 is a schematic diagram illustrating a control system for controlling the motor and the worm gear arrangement of FIGS. 2 and 3 in accordance with embodiments;

FIG. 5 illustrates current consumption patterns of conventional and smart gauges in accordance with embodiments;

FIG. 6 is a flow diagram illustrating an operation of the control system of FIG. 4 in accordance with embodiments; and

FIG. 7 is a flow diagram illustrating a method of operating a smart gauge in accordance with embodiments.

These and other advantages and features will become more apparent from the following description taken in conjunction with the drawings.

### DETAILED DESCRIPTION

As will be described below, an analog display gauge is provided and includes a needle that signifies a measured value or quantity, a motor and a worm gear arrangement where the worm gear arrangement is driven by the motor to position the needle to signify a particular measured value or quantity and a power source to power the motor. The motor, with the worm gear arrangement, is only energized to draw power from the power source if there is a sudden and/or significant change in the measured value or quantity so that, in the absence of such a change, the needle retains its current position and no power is drawn from the power source. Where the power source is a battery or another similar device, the energizing of the motor with the worm gear arrangement only in an event of a sudden change in the measure value or quantity preserves charge and allows the battery to have a longer life.

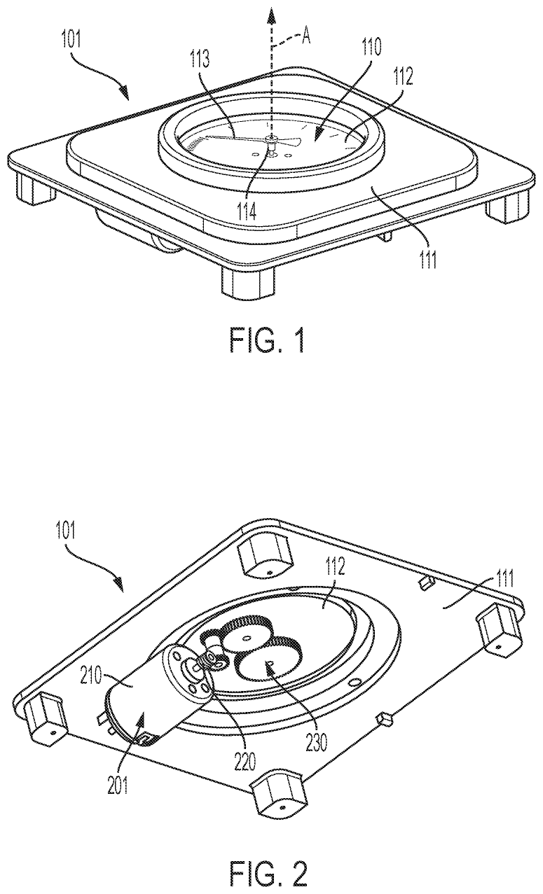

With reference to FIGS. 1-3, a gauge device 101 is provided and includes an analog display 110 to signify a measured valued. The analog display 110 can take multiple forms depending on the type of measured value and the application it is used for. As an example, the analog display 110 can include a plate member 111 for support, a numbered background 112 and a needle element 113 that can pivot about a rotational axis A of shaft 114 to point to any portion of the numbered background to signify the measured value. In this or other cases, the measured value can include a vehicle (i.e., aircraft, automobile, etc.) parameter that changes too slowly for human perception and the vehicle parameter can include one or more of pressure information, temperature information, fuel level information, etc.

Although the analog display 110 can take multiple forms, the following description will relate to the case in which the analog display 110 is configured as shown in FIGS. 1 and 2 and as described above. This is done for purposes of clarity and brevity and is not intended to otherwise limit the scope of the application as a whole.

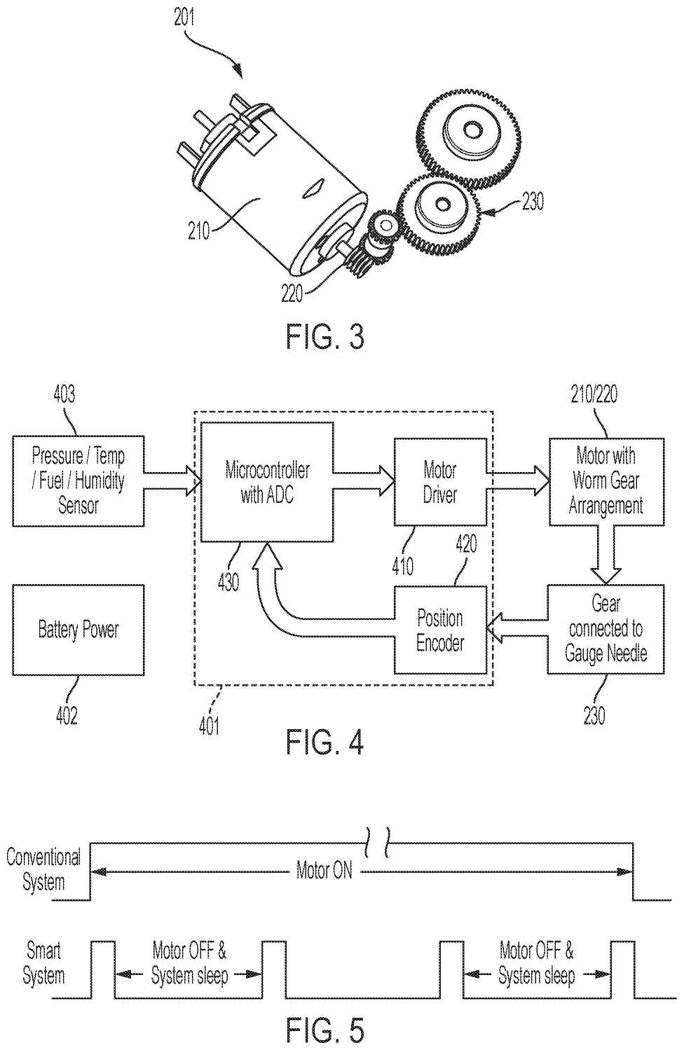

As shown in FIGS. 2 and 3, the gauge device 101 further includes a motor and worm gear arrangement 201. The motor and worm gear arrangement 201 is supported on the plate member 111 and is coupled to the shaft 114 and the needle element 113. The motor and worm gear arrangement 201 includes a bi-directional motor 210, a worm gear 220 disposed on an output shaft of the bi-directional motor 210 and a gear train 230 operably interposed between the worm gear 220 and the shaft 114. As such, when the motor 210 operates in a forward mode, the output shaft turns the worm gear 220 in a forward direction, the worm gear 220 turns the gear train 230 in the forward direction and the gear train 230 in turn rotates the shaft 114 and the needle element 113 about the rotational axis A in the forward direction. By contrast, when the motor 210 operates in a reverse mode, the output shaft turns the worm gear 220 in a reverse direction, the worm gear 220 turns the gear train 230 in the reverse direction and the gear train 230 in turn rotates the shaft 114 and the needle element 113 about the rotational axis A in the reverse direction. When the motor 210 is non-operative, no rotation occurs in the output shaft, the worm gear 220 and the gear train 230 and thus the shaft 114 and the needle element 113 are kept still.

The motor and worm gear arrangement 201 are configured to assume a de-energized state or an energized state. In the de-energized state, the motor 210 is effectively non-operative so that the shaft 114 and the needle element 113 are kept still and a current state of the analog display 110 is maintained. In the energized state, the motor 210 is operated in either the forward or the reverse mode whereby the motor and worm gear arrangement 201 drive a change in the analog display 110.

With continued reference to FIGS. 1-3 and with additional reference to FIG. 4, the gauge device 101 further includes a control system 401, a battery 402 and one or more sensors 403 to provide readings of the measured value.

The control system 401 can be local or remote (wired or wireless) from the motor and worm gear arrangement 201 and is configured to normally maintain the motor and worm gear arrangement 201 in a state in which the motor and worm gear arrangement 201 is de-energized and does not draw power from the battery 402. This condition persists in accordance with a calculated or target state of the analog display 110, which is calculated in accordance with readings of the measured value received by the control system 401 from the one or more sensors 403, differing from the current state of the analog display 110 by less than a threshold level. The threshold level can be, but is not required to be, a level of change that is barely perceptible to a human. That is, in the case of the analog display 110 being provided as shown in FIGS. 1 and 2, the threshold level can be a rotation of the needle element 113 about the rotational axis A by an angle that is barely perceptible to a human. The control system 401 is further configured to energize the motor and worm gear arrangement 201 only in accordance with the calculated or target state differing from the current state by at least the threshold level. When the control system 401 energizes the motor and worm gear arrangement 201, the motor and worm gear arrangement 201 draws power from the battery 402.

The battery 402 can be provided as a single-charge battery or as a rechargeable battery and, in either case, the battery 402 has a limited amount of charge available to energize the motor and worm gear arrangement 201 at any particular time.

As shown in FIG. 4, the control system 401 includes a motor driver 410, a position encoder 420 and a microcontroller 430. The motor driver 410 is configured to energize the motor and worm gear arrangement 201 to operate in either forward or reverse directions. The position encoder 420 is configured to generate a first signal S1 indicative of the current state of the analog display 210. That is, in the case of the analog display 110 being provided as shown in FIGS. 1 and 2, the first signal S1 is indicative of an angular position of the needle element 113. The microcontroller 430 can include or be provided as a processing unit, a memory unit and an input/output (I/O) unit. In any case, the microcontroller 430 is configured to periodically receive the first signal S1 from the position encoder 420, to recognize the current state from the first signal S1, to calculate the calculated or target state of the analog display 110 in accordance with readings of the measured value that are received by the microcontroller 430 from the one or more sensors 403, to compare the calculated or target state with the current state and to generate a second signal Si that instructs the motor driver 410 to energize the motor and worm gear arrangement 201 based on comparison results.

With the control system 401 configured as described above, the control system 401 only energizes the motor and worm gear arrangement 201 to draw limited power from the battery 402 when the calculated or target state of the analog display 110 differs from the current state of the analog display 110 by the threshold level. In this way, the control system 401 limits an amount of power drawn from the battery 402, which, in turn, extends a life of the battery 402. This effect is particularly apparent in a case where the measured value is a value that changes very slowly (i.e., by a degree which is imperceptible to a human, such as pressure, temperature, humidity, fuel status, etc.)

With reference to FIG. 5, the above-described effect is illustrated in comparison to a conventional system. As shown in FIG. 5, in a conventional system, power is drawn continuously by a motor of a gauge device to maintain the analog or digital display in an “on” state. By contrast, the motor and worm gear arrangement 201 maintains or retains the current state of the analog display 110 and the control system 401 only energizes the motor and worm gear arrangement 201 when it is necessary for the motor and worm gear arrangement 201 to assume the “on” state to thereby effect a change in the state of the analog display 110 (i.e., when the threshold is exceeded and the change to be effected in the state of the analog display 110 is barely perceptible to a human).

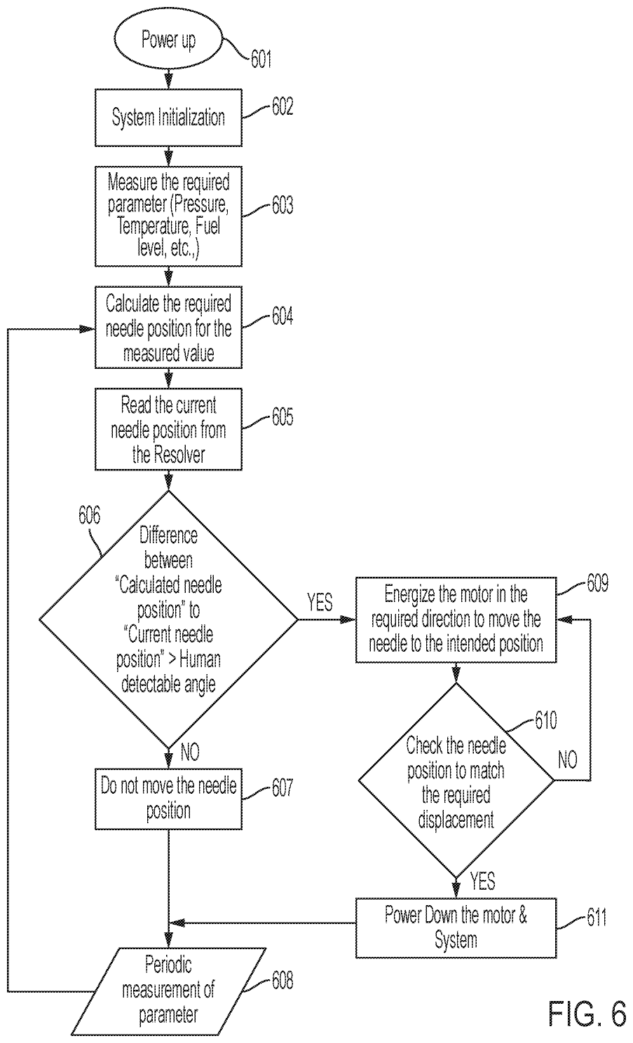

With reference to FIG. 6, an operational sequence of the control system 401 of FIG. 4 will now be described. As shown in FIG. 6, the control system 401 is powered up (601), initialized (602) and receptive of the readings of the one or more sensors 403 (603). At this point, the control system 401 calculates the required position (i.e., the calculated or target position) of the needle element 113 for the measured value in accordance with the readings (604), reads the current position of the needle element 113 (605) and determines through a comparison whether the difference between the required position and the current position of the needle element 113 exceeds the threshold by being greater than a human detectable angle (606). If not, the needle element 113 is not moved (607) and the control system 401 begins periodically checking the readings (608) with control reverting to 604. If the difference between the required position and the current position of the needle element 113 exceeds the threshold, the motor and worm gear arrangement 201 are energized in the appropriate direction (609) and the position of the needle element 113 is checked to determine whether the required position is achieved (610). If not control reverts to 609. If so, the motor and worm gear arrangement 201 are de-energized (611) and control reverts to 608.

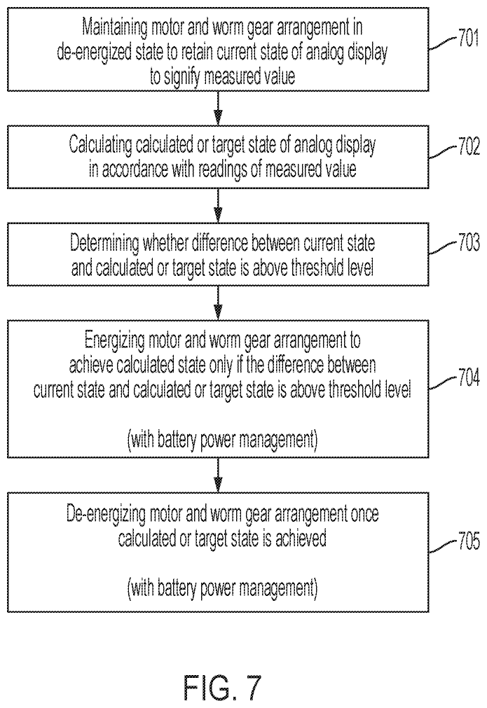

With reference to FIG. 7, a method of operating a gauge device as described above is provided. As shown in FIG. 7, the method includes maintaining a motor and worm gear arrangement in a de-energized state to retain a current state of an analog display to signify a measured value (701), calculating a calculated or target state of the analog display in accordance with readings of the measured value (702), determining whether a difference between the current state and the calculated or target state is above a threshold level (703) and energizing the motor and worm gear arrangement to achieve the calculated state only in an event the difference between the current state and the calculated or target state is above the threshold level (704). In addition, the method can further include de-energizing the motor and worm gear arrangement once the calculated or target state is achieved (705). The measured value includes, but is not limited to, a vehicle parameter that changes too slowly for human perception, the vehicle parameter includes, but is not limited to, one or more of pressure information, temperature information and fuel level information and the threshold level is a difference that is barely perceptible to a human.

In accordance with embodiments, the energizing and the de-energizing of the motor and worm gear arrangement can include battery power management operations to reduce energy consumption and increase battery and total product life.

Technical effects and benefits of the features described herein are the provision of a gauge device that combines the benefits of analog and digital technologies to integrate high accuracy digital sensors that require low power and offer increased battery life with reduced or zero power consumption when not in use. As explained above, although the gauge device includes a digital system, it does not consume power for displaying a same sensor value as the worm gear arrangement will retain the needle position without any power applied and battery power is effectively used to drive the motor only when required.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A gauge device, comprising:
an analog display to signify a measured valued;
a motor and worm gear arrangement which is configured to retain a current state of the analog display when de-energized or to change the analog display when energized; and
a control system configured to normally de-energize the motor and worm gear arrangement and to energize the motor and worm gear arrangement only in accordance with a calculated state of the analog display differing from the current state by at least a threshold level.

2. The gauge device according to claim 1, wherein:
the measured value comprises a vehicle parameter that changes too slowly for human perception, and
the vehicle parameter comprises one or more of pressure information, temperature information and fuel level information.

3. The gauge device according to claim 1, wherein the analog display comprises a numbered background and a needle disposed to point to any portion of the numbered background to signify the measured value.

4. The gauge device according to claim 1, wherein the motor and worm gear arrangement comprises:
a bi-directional motor;
a worm gear disposed on an output shaft of the bi-directional motor; and
a gear train operably interposed between the worm gear and the analog display.

5. The gauge device according to claim 1, further comprising a battery from which power is drawn to energize the motor and worm gear arrangement.

6. The gauge device according to claim 1, wherein the control system comprises one or more sensors to provide readings of the measured value.

7. The gauge device according to claim 1, wherein the control system comprises:
a motor driver configured to energize the motor and worm gear arrangement;
a position encoder configured to generate a first signal indicative of the current state of the analog display; and
a microcontroller configured to receive the signal from the position encoder, to recognize the current state from the first signal, to calculate the calculated state of the analog display in accordance with readings of the measured value, to compare the calculated and current states and to generate a second signal that instructs the motor driver to energize the motor and worm gear arrangement based on comparison results.

8. The gauge device according to claim 1, wherein the threshold level is a level of change that is barely perceptible to a human.

9. A gauge device, comprising:
an analog display to signify a measured value;
a motor and worm gear arrangement to retain a current state of the analog display when de-energized and to drive a change in the analog display when energized; and
a control system configured to normally maintain the motor and worm gear arrangement in a state in which the motor and worm gear arrangement is de-energized in accordance with a calculated state of the analog display differing from the current state by less than a threshold level and to energize the motor and worm gear arrangement only in accordance with the calculated state differing from the current state by at least the threshold level.

10. The gauge device according to claim 9, wherein:
the measured value comprises a vehicle parameter that changes too slowly for human perception, and
the vehicle parameter comprises one or more of pressure information, temperature information and fuel level information.

11. The gauge device according to claim 9, wherein the analog display comprises a numbered background and a needle disposed to point to any portion of the numbered background to signify the measured value.

12. The gauge device according to claim 9, wherein the motor and worm gear arrangement comprises:
a bi-directional motor;
a worm gear disposed on an output shaft of the bi-directional motor; and
a gear train operably interposed between the worm gear and the analog display.

13. The gauge device according to claim 9, further comprising a battery from which power is drawn to energize the motor and worm gear arrangement.

14. The gauge device according to claim 9, wherein the control system comprises one or more sensors to provide readings of the measured value.

15. The gauge device according to claim 9, wherein the control system comprises:
a motor driver configured to energize the motor and worm gear arrangement;
a position encoder configured to generate a signal indicative of the current state of the analog display; and
a microcontroller configured to receive the first signal from the position encoder, to recognize the current state from the first signal, to calculate the calculated state of the analog display in accordance with readings of the measured value, to compare the calculated and current states and to generate a second signal that instructs the motor driver to energize the motor and worm gear arrangement based on comparison results.

16. The gauge device according to claim 9, wherein the threshold level is a level of change that is barely perceptible to a human.

17. A method of operating a gauge device, the method comprising:
maintaining a motor and worm gear arrangement in a de-energized state to retain a current state of an analog display to signify a measured value;
calculating a calculated state of the analog display in accordance with readings of the measured value;
determining whether a difference between the current and calculated states is above a threshold level;
energizing the motor and worm gear arrangement to achieve the calculated state only in an event the difference between the current and calculated states is above the threshold level; and
de-energizing the motor and worm gear arrangement once the calculated state is achieved.

18. The method according to claim 17, wherein:
the measured value comprises a vehicle parameter that changes too slowly for human perception, and
the vehicle parameter comprises one or more of pressure information, temperature information and fuel level information.

19. The method according to claim 17, wherein the threshold level is a difference that is barely perceptible to a human.

20. The method according to claim 17, wherein the energizing and the de-energizing comprises battery power management.
